(19) United States
(12) Patent Application Publication
(10) Pub. No.: US 2018/0115222 A1
(43) Pub. Date: Apr. 26, 2018

(54) DEVICE FOR AN ELECTRIC MOTOR

(71) Applicant: BAE Systems Hägglunds Aktiebolag, Örnsköldsvik (SE)

(72) Inventor: Viktor LASSILA, Arnäsvall (SE)

(73) Assignee: BAE Systems Hägglunds Aktiebolag, Örnsköldsvik (SE)

(21) Appl. No.: 15/567,572

(22) PCT Filed: Apr. 7, 2016
(86) PCT No.: PCT/SE2016/050292

§ 371 Date: Oct. 18, 2017

(30) Foreign Application Priority Data
Apr. 23, 2015 (SE) 1550484-8

(51) Int. Cl. H02K 9/22; H02K 1/16; H02K 3/24; H02K 9/19; H02K 3/12; H02K 3/487

(52) U.S. Cl. CPC H02K 9/22; H02K 1/165; H02K 3/487; H02K 9/19; H02K 3/12; H02K 3/24

(57) ABSTRACT

The present invention relates to a device for an electric motor having a rotor and a stator. The stator is provided with circumferentially of the stator distributed frame portions between forming spaces for a stator winding. Said frame portions are arranged to support the stator winding, wherein means are provided for retaining the stator winding in a thus formed space in place and for providing a short circuit protection function for the stator winding in said space. Said means comprises cooling member, which are in thermally conductive contact with a back portion of said stator for purpose of cooling. The invention also relates to a platform.

### TECHNICAL FIELD

The invention relates to a device for an electric motor according to the preamble of claim 1. The invention also relates to a motor vehicle.

### BACKGROUND

During operation electric motor are heated wherein cooling is required to divert the heat. Traditionally a lot of heat is transported out from the winding through the stator back to the housing of the electric motor. This results in that the winding, in a cross section of the motor will be hottest in the middle.

When heat from the winding is to be transported out through the stator back it will have to pass through several thermal barriers, since each winding wire has an isolating layer. The stator winding generally comprises a lacquered, isolated conductor, normally copper. Hereby barriers in the form of copper/lacquer, lacquer/copper, lacquer/lacquer needs to be passed through. This results in a considerable temperature gradient in the stator slot.

Upon traditional manufacture of electric motors the winding of the stator requires a vast amount of manual work. One way to automate the winding process is to separately wind every stator teeth, either by means of a preformed winding or by means of a robot that winds the winding around one tooth at the time.

With such automated winding, especially with preformed winding coils it is difficult to achieve a satisfactory fill factor in each slot. This results in a further reduction of the heat transfer.

In an electric motor a wedge is generally situated furthest away in the slot so as to lock the winding so that it not is able to end up in the air gap and come into contact with the rotor.

EP1215801 show a device for an electric motor with a T-shaped wedge arranged in spaces of the stator to facilitate circulation of cooling oil. This T-shaped wedge is preferable made of an elastic material in order to improve the sealing in the space. The T-shaped wedge is according to a variant made of resin as an isolator. The purpose of the leg of the wedge is to reduce the cross sectional area of the cooling passage for the cooling oil and for improved cooling. The leg of the wedge is intended to create a barrier in the space and thereby create two cooling conduits in the same space.

### OBJECT OF THE INVENTION

An object of the present invention is to achieve a device for an electric motor that enables efficient cooling of the electric motor.

### SUMMARY OF THE INVENTION

These and other objects, apparent from the following description, are achieved by a device of the type stated by way of introduction and which in addition exhibits the features recited in the characterising clause of the appended independent claim 7. Furthermore, these objects are achieved by a platform according to claim 7. Preferred embodiments of the device and platform are defined in the appended dependent claims 2-6 and 8.

According to the invention these objects are achieved by a device for an electric motor having a rotor and a stator. The stator is provided with circumferentially of the stator distributed frame portions between them forming spaces for a stator winding. Said frame portions being arranged to support the stator winding wherein means are provided for retaining the stator winding in a thus formed space in place and to provide a short circuit protection function for the stator winding in said space. Said means comprises cooling members, which are in thermally conductive contact with a back portion of said stator for purpose of cooling. By means of that the cooling members thus are in thermally conductive contact with the back portion of the stator a thermally transporting barrier is formed which results in that the heat avoid passing as many thermal barriers in the form of isolation layers which reduces the temperature gradient in the track. Thus, by means of transporting heat a more efficient cooling of the electric motor is achieved. An electric motor with a thus configured device is well suited for an automated winding process wherein each stator tooth is separately wound, either by means of a preformed winding or by means of a robot winding the winding around one tooth at the time, wherein the fill factor in each space/track, wherein the fill factor is relatively low.

According to an embodiment of the device said cooling member comprises thermally conductive portions, of said means, extending radially of the stator. Hereby efficient heat transport of the space is provided.

According to an embodiment of the device said means are formed by portions having a substantially T-shaped cross section across the stator winding. Hereby is enabled both efficient retention of the stator winding in the space, short circuit protection and efficient cooling of the stator winding by means of heat transport.

According to an embodiment of the device said cooling members comprise stator back portions extending radially from the stator back. Hereby is enabled efficient use of the stator back for providing a heat transporting barrier.

According to an embodiment of the device said stator back portions extending radially from the stator comprises said portions with a substantially T-shaped cross section. By means of constructing the stator back to have portions with T-shaped cross section in the opening efficient retention of the stator winding in the space, short circuit protection function and efficient cooling of the stator winding by means of heat transport using the stator back is provided. Consequently the full function of short circuit, retention and heat transport/cooling is provided by one and the same part of the stator back.

According to an embodiment of the device said short circuit protection function is arranged to be provided by means of portions of said means being arranged to separate stator winding portions in said space. Hereby is provided an efficient short circuit protection function.

According to an embodiment of the device said cooling members comprises axially extending conduits for flow of cooling medium. Hereby is enabled efficient cooling by means of cooling medium in the form of for example oil without the air gap at the side of the stator facing the rotor has to be sealed.

### DESCRIPTION OF THE DRAWINGS

A better understanding of the present invention will be had upon the reference to the following detailed description when read in conjunction with the accompanying drawings, wherein like reference characters refer to like parts throughout the several views, and in which:

FIG. 1 schematically illustrates a platform according to an embodiment of the present invention;

FIG. 2 schematically illustrates an axial cross section view of an electric motor according to an embodiment of the present invention;

FIG. 3 schematically illustrates a radial cross section view of part of an electric motor having a device for an electric motor according to an embodiment of the present invention;

FIG. 4 schematically illustrates a radial cross section view of part of an electric motor having a device for an electric motor according to an embodiment of the present invention;

FIG. 5 schematically illustrates a radial cross section view of part of an electric motor having a device for an electric motor according to an embodiment of the present invention; and

FIG. 6 schematically illustrates a cross section view of means for retention of a stator winding and a short circuit protection function comprising cooling members for cooling of the electric motor according to an embodiment of the present invention.

### DESCRIPTION OF EMBODIMENTS

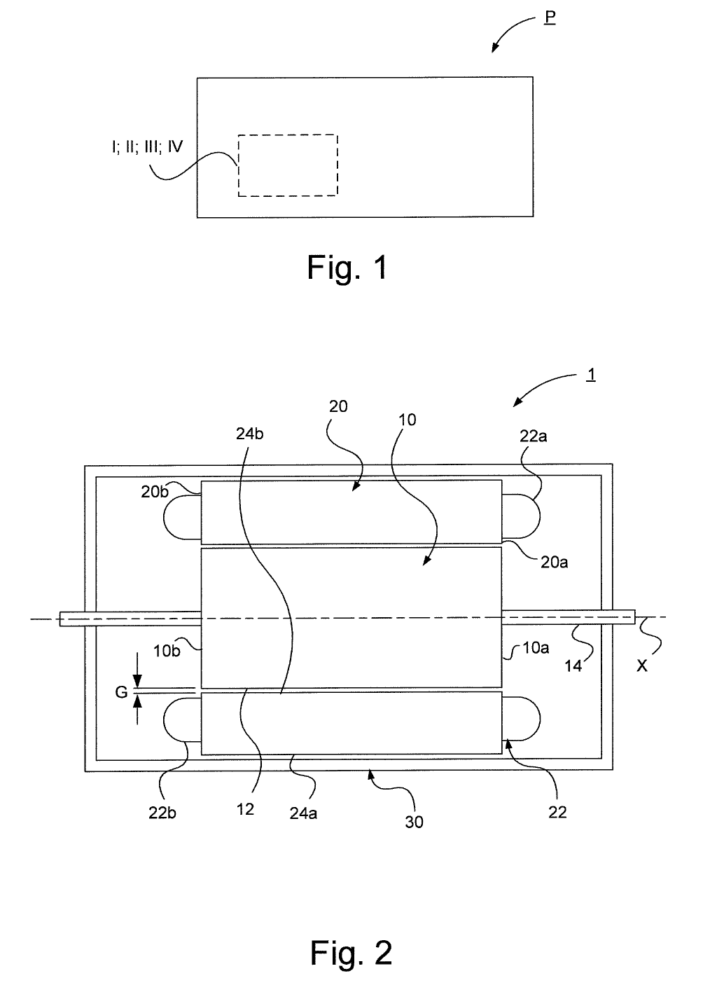

With reference to FIG. 1 a platform P is shown, wherein the platform P is comprised in a group comprising motor vehicles such as military vehicles, work vehicles, automobiles, boat, helicopter or similar, a power station, any electrically driven machine or corresponding device wherein the device comprises an electric motor for operation of the device. The platform P comprises at least one electric motor 1 comprising a device 1 for liquid cooling of the electric motor 1 according to the present invention.

In an embodiment in which the electric motor 1 is comprised in a motor vehicle the electric motor 1 is configured for operation of said motor vehicle, which thus constitutes an electrically driven motor vehicle. The device I for the electric motor may be configured according to any of the below described embodiments.

FIG. 2 schematically illustrates an axial cross section view of an electric motor 1 having a device 1 for liquid cooling of the electric motor according to an embodiment of the present invention.

The electric motor 1 is of inner rotor type comprising a rotor 10 and a stator 20 being provided with a winding. With electric motor 1 of inner rotor type is meant an electric motor 1 wherein the stator 20 is arranged to surround the rotor 10. The exterior surface of the rotor 10 is arranged adjacently and separated from the interior surface of the stator 20. The rotor 10 is according to a variant structured by on top of each other stacked rotor plates, not shown. In an extremely high speed electric motor, for example an electric motor in gas turbine operation, the rotor is solid instead structured by rotor plates/laminated. The rotor 10 is arranged concentrically relative to the stator 20. Hereby according to an embodiment the centre axis's of the rotor 10 and the stator 20 substantially coincides with a centre axis X of the electric motor 1. The centre axis's of the rotor 10 and the stator may according to an alternative embodiment be arranged eccentrically relative to the centre axis of the electric motor 1.

Said rotor 10 is intended to be attached to a driving axle, not shown, and is thus arranged to rotate with the driving axle or be rotated by the driving axle. The rotor 10 has opposite end portions in the form of rotor ends 10a, 10b. The rotor ends 10a, 10b constitutes end surfaces of the cylinder shaped rotor 10.

The rotor 10 has an envelope surface 12 facing the stator 20 and constitutes what is herein referred to as the exterior surface of the rotor. The electric motor 1 further comprises a rotor shaft 14 coupled to the rotor 10 and extending axially from at least one rotor end 10a, 10b. The rotor shaft 14 is generally also cylinder shaped and arranged concentrically with the rotor 10 and the stator 20 so that its centre axis coincides with said centre axis X of the electric motor 1. The rotor shaft 14 may be a one sided rotor shaft extending from one side of the electric motor 1 or it may be, as illustrated in FIG. 2, a double sided rotor shaft extending from both sides of the electric motor 1.

During operation of the electric motor 1 the rotor 10 and thereby also the rotor shaft 14 are caused to rotate, wherein the rotor shaft 14 is arranged to transfer a driving torque to drive means (not shown) outside of the electric motor, for example for propulsion of an electrically driven motor vehicle. Alternatively the electric motor may be driven by the vehicle, wherein the electric motor brakes by means of generating a negative torque, wherein the electric motor consequently acts as a generator.

The stator 20 is according to a variant structured by on top of each other stacked stator plates (not shown). The stator 20 comprises a stator winding 22. The stator winding comprises according to a variant a set of electrically conductive wires/conductors, preferably copper wires, through which a current may be arranged to be conducted for operation of the electric motor 1. Said wires may be of different thickness. Said stator winding 22 is, for an electric motor 1 of inner rotor type, arranged to extend axially so that the winding is nearby adjacent to the rotor 10. The stator winding 22 is arranged to extend axially from end portions 20a, 20b of the stator 20, turn outside of the end portions 20a, 20b and to be re-introduced through the end portions, whereby said extending portion 22a of the stator winding 22 forms a so called coil end 22b.

The electrically conductive wires of the stator 20 are according to a variant arranged to extend axially in spaces in the form of slots or apertures of said stator plates, wherein the different wire segments are arranged to be guided out from the end portions 20a, 20b of the stator 20 from a slot or aperture of the stator plates and back into a different slot or aperture of the stator plates.

The stator 20 of the electric motor 1 of inner rotor type also has an envelope surface 24a. The 20 stator thereby constitutes a cylindrical shell surrounding the rotor 10 so that the envelope surface 12a of the rotor is completely surrounded by an interior surface or inner surface 24b of the stator 20 in a radial direction of the rotor 10. The exterior surface alike envelope surface 12 of the rotor 10 is arranged nearby adjacently and separated from said interior surface 24b of the stator 20, wherein an air gap G is formed between the rotor 10 and the stator 20.

The stator winding 22 of the stator is according to the present invention arranged to extend along and axially protruding from and turn outside of the envelope surface of the stator 20.

The electric motor 1 further comprises a motor housing 30 surrounding the components comprised in the electric motor 1, including the rotor 10 and the stator 20.

Above an electric motor 1 of inner rotor type has been described. The present invention may advantageously be used for an electric motor of outer rotor type, wherein the cooling runs in the motor centre, or an electric motor of axial flow type, wherein the cooling surrounds the electric motor.

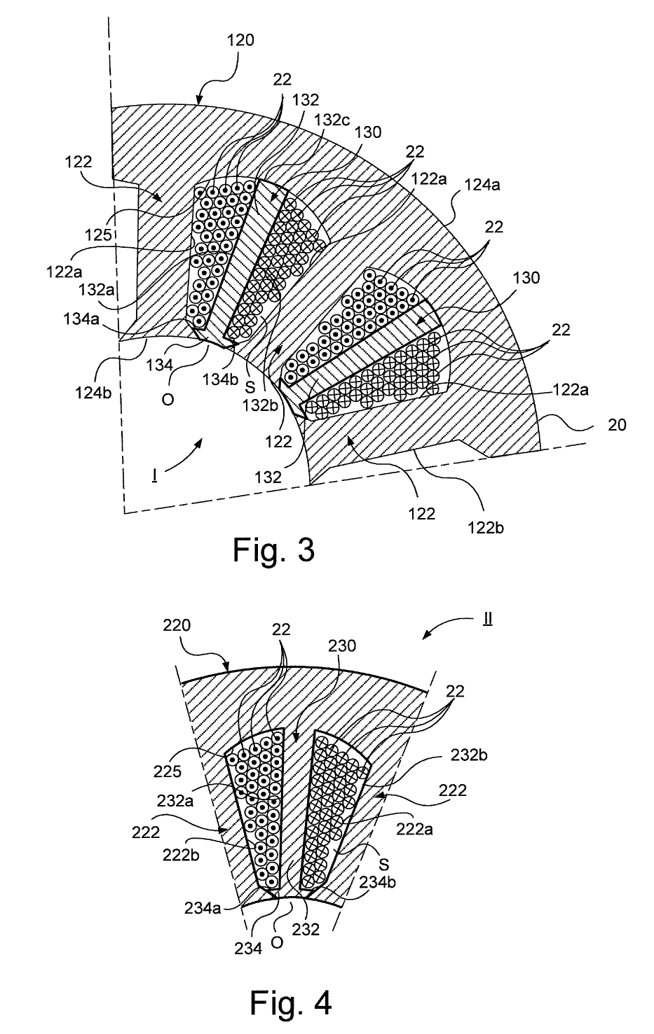

FIG. 3 schematically illustrates a radial cross section view of part of an electric motor having a device I for an electric motor according to an embodiment of the present invention. The electric motor according to a variant constitutes an electric motor in accordance with the electric motor 1 illustrated in FIG. 2.

FIG. 3 illustrates part of the stator 120 of the electric motor. The stator 120 is provided with circumferentially of the stator distributed frame portions 122 between forming spaces S or tracks S for the stator winding 22. Said frame portions 122 forms so called stator teeth. Said frame portions 122 have a first side 122a and an opposing second side 122b. The first side 122a of a frame portion and the second side 122b of an adjacent frame portion 122 consequently delimit such space S.

Said frame portions 122 are arranged to support the stator winding 22 wherein means 130 are provided for retaining the stator winding 22 in a thus formed S in place and for providing a short circuit protection function for the stator winding 22 in said space S. Said means 130 comprises cooling members 132, which are in thermally conductive contact with a back portion 125 of said stator 120 for purpose of cooling.

By means of the cooling members 132 thus being in thermally conductive contact with the back portion 125 of the stator a heat transporting barrier is formed which results in that the heat avoids passing as many thermal barriers in the form of layers of isolation of the stator winding which reduced the temperature gradient of the space S. By means of thus transport of heat a more efficient cooling of the electric motor is provided.

Said cooling members 132 comprise thermally conductive portions, of said means, extending radially of the stator 120. The cooling member 132 has a first side 132a and an opposing second side 132a and an end 132c facing and thermally conductive abutting the back portion 125.

Said means 130 are formed by means of portions 132, 134 with a substantially T-shaped cross section across the stator winding. The means 130 consequently comprises a retention portion 134 having an extension across the extension of the cooling member extending radially of the stator.

The retention portion 134 and the cooling member 132 according to this embodiment are comprised by one unit or a joint piece. The means 130 comprises the radially from the substantially radially inwards facing interior back portion 125 of the space S of the stator extending cooling 132 member which in connection to the opening O of the space S facing the rotor transcends into the retention portion 134.

The retention portion 134 extends substantially circumferentially from respective side of the cooling member 132 covering the opening. The retention portion 134 hereby has a side 134a outwardly facing the envelope surface 124a of the stator 120, against which side the stator winding rests. The retention portion 134 hereby retains the stator winding 22 in the space S.

The thermally conductive cooling member 132 is arranged to divide the space S so that the stator winding 22 ends up on a respective 132a, 132b of the cooling member 132 so as to offer the short circuit protection function and the thermally conductive function.

The stator winding 22 is here separately wound around each frame portion 122. The stator winding 22 may also be wound in a different way such as around two or more frame portions 122. Hereby, in FIG. 3 the stator winding 22 is wound around the midmost frame portion 122 and extends to the left of the frame portion 122 inwards in the figure and to the right of the frame portion outwards in the figure and turns in so called coil ends at end portion of the electric motor such as illustrated in FIG. 2. Consequently it is the by means of the cooling member 132 divided portion of the stator winding to the right of the cooling member 132 in the left space S and the by means of the cooling member 132 divided portion of the stator winding 22 to the left of the cooling member in the right space that constitutes the winding around the midmost frame portion 122 of the stator. Thus, by means of winding the stator winding separately around each frame portion/stator tooth 122 automation of the winding process is facilitated, wither by means of using a preformed winding or by means of using a robot the winds the winding around one tooth at the time.

Hereby is enabled both efficient retention of the stator winding in the space, short circuit protection functionality and efficient cooling of the stator winding by means of heat transport.

FIG. 4 schematically illustrated a radial cross section view of part of an electric motor with a device II for an electric motor according to an embodiment of the present invention. The electric motor according to a variant comprises an electric motor in accordance to the electric motor 1 illustrated in FIG. 2.

The embodiment in FIG. 4 differs from the embodiment in FIG. 3 in the configuration of the means for retaining the stator winding in place and for providing a short circuit protection function for the stator winding in the spaces/tracks of the stator.

FIG. 4 illustrates a portion of the stator 220 of the electric motor. The stator 220 is provided with circumferentially of the stator distributed frame portions 222 between forming spaces S or tracks S for the stator winding 22. Said frame portions 122 forms so called stator teeth. Said frame portions 222 have a first side 222a and an opposing second side 222b. The first side 222a of a frame portion and the second side 222b of the frame portion of an adjacent frame portion 222 consequently delimit such a space S.

Said frame portions 222 are arranged to support the stator winding 222 wherein means 230 are provided for retaining the stator winding 22 in a thus formed space S in place and for providing a short circuit protection function for the stator winding 22 in said space S. Said means 230 comprises a cooling member 232, which are in thermally conductive contact with a back portion 224 of said stator 220 for purpose of cooling.

Said cooling member 232 comprises thermally conductive portions, of said means, extending radially of the stator 220. The cooling member 232 has a first side 232a and an opposing second side 232a.

Said means 230 are formed by means of portions 232, 234 having a substantially T-shaped cross section across the stator winding. The means 230 consequently comprises a retention portion 234 having an extension across the extension of the cooling member 232 extending radially of the stator.

According to this embodiment said cooling member 232 comprises stator back portions radially extending from the stator back, wherein the portions comprises said retention portions 234 having a substantially T-shaped cross section. Consequently the means 230 comprises portions extending radially from the stator back forming the cooling member 232 which transcends into the retention portion 234 in connection to opening of the space S facing the rotor. By means of constructing the stator back to have portions with a T-shaped cross section in the opening efficient retention of the stator winding in the space, short circuit protection function and efficient cooling of the stator winding by means of heat transport by the stator back is provided. Consequently, the full function of short circuit, retention and heat transport/cooling is provided by means of one and the same piece of the stator back.

By means of the cooling member 232 thus being in thermally conductive contact with the back portion by means of the configuring of the cooling member with said portion of the stator 220 radially extending from the back portion of the stator a heat transporting barrier is formed which results in that the heat avoids passing as many thermal barriers in the form of layers of isolation of the stator winding which reduces the temperature gradient in the space S. By thus transport of heat a more efficient cooling of the electric motor is provided.

The retention portion 234 and the cooling member 232 according to this embodiment is comprised of one unit or one joint piece of a portion of the back portion of the stator, wherein the cooling member 232 in connection to the opening O of the space S transcends into the retention portion 234.

The retention portion 234 extends substantially circumferentially from the respective side of the cooling member 234 covering the opening O. The retention portion 234 hereby has side 234a, 234b outwardly facing the envelope surface 224a of the stator 220, against which side the stator winding 22 rests. The retention portion 234 hereby retains the stator winding 22 in the space S.

The thermally conductive cooling member 232 is arranged to divide the space S so that the stator winding 22 ends up on a respective side 232a, 232b of the cooling member 232 providing a short circuit protection function and a thermally conductive function.

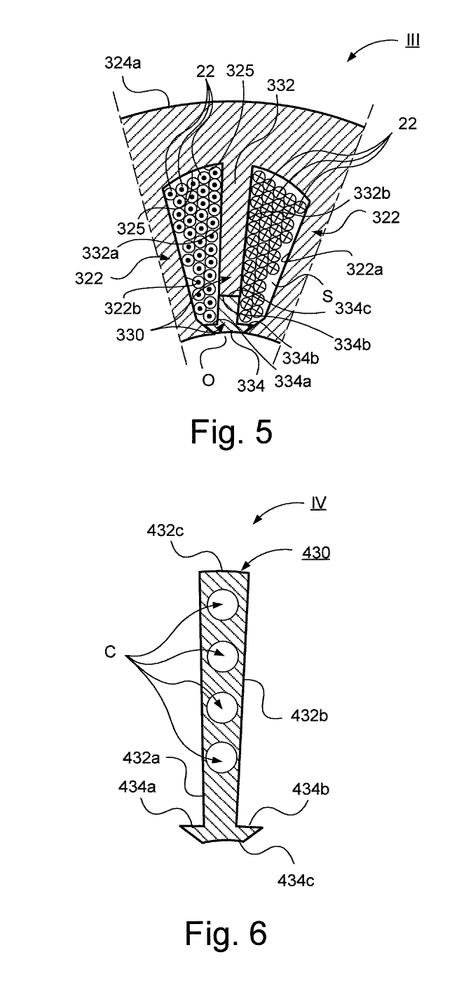

FIG. 5 schematically illustrates a radial cross section view of part of an electric motor having a device III for an electric motor according to an embodiment of the present invention. The electric motor according to a variant comprises an electric motor in accordance to the electric motor 1 illustrated in FIG. 2.

The embodiment in FIG. 5 differs from the embodiment in FIG. 4 in the configuration of the means for retaining the stator winding in place and for providing a short circuit protection function for the stator winding in the spaces/tracks of the stator.

FIG. 5 illustrates a portion of the stator 320 of the electric motor. The stator 320 is provided with circumferentially of the stator distributed frame portions 322 between forming spaces S or tracks S for the stator winding 22. Said frame portions 322 forms so called stator teeth. Said frame portions 322 have a first side 322a and an opposing second side 322b. The first side 322a of a frame portion and the second side 322a of an adjacent frame portion 322 thus delimit such a space S.

Said frame portions 322 are arranged to support the stator winding wherein means 330 are provided for retaining the stator winding 22 in a thus formed space in place and for providing a short circuit protection function for the stator winding 22 in said space S. Said means 330 comprises cooling members 332, which are in thermally conductive contact with a back portion 325 of said stator 320 for purpose of cooling.

Said cooling member 332 comprises portions of said means 330 extending radially of the stator. The cooling member 332 has a first side 332a and an opposing second side 332a.

Said means 330 are formed by means of portions 332, 334 with a substantially T-shaped cross section across the stator winding. The means 330 consequently comprises a retention portion 334 having an extension across the extension of the cooling member 332 extending radially of the stator.

According to this embodiment said cooling member 332 comprises stator back portions extending radially of the stator back. Consequently the means 330 comprises portions extending radially from the stator back forming the cooling member 332. The cooling member 332 has an end portion 332c facing the opening O and consequently facing away from the envelope surface of the stator 320.

The retention portion 334 extends substantially circumferentially from the respective side of the cooling member 332 covering the opening O. The retention portion 334 hereby has a side 334a, 334c outwardly facing the envelope surface 324a of the stator 320 against which side the stator winding 22 rests. The retention portion 334 hereby retains the stator winding 22 in the space S.

The retention portion 334 according to this embodiment comprises a separate unit with an end portion 334c facing and abutting the end portion 332c of the cooling member 332.

By means of the cooling member 332 thus being in thermally conductive contact with the back portion by means of the configuring of the cooling member with said portion of the stator 320 radially extending from the back portion of the stator a heat transporting barrier is formed which results in that the heat avoids passing as many thermal barriers in the form of layers of isolation of the stator winding which reduces the temperature gradient in the space S. By means of thus transport of heat a more efficient cooling of the electric motor is provided.

The thermally conductive cooling member 332 is arranged to divide the space S so that the stator winding ends up on a respective side 332a, 332b of the cooling member providing the short circuit protection function and the heat conductive function.

FIG. 6 schematically illustrates a cross section view of means 430 of a device IV for retention of the stator winding and short circuit protection function comprising the cooling member 432 for cooling of the electric motor according to an embodiment of the present invention.

The means 430 substantially corresponds to the means 130 in FIG. 3. The means consequently comprises a cooling member 430 arranged to extend radially in spaces/tracks of the stator and retention portion 434 for retention of the stator winding. The cooling member 432 has a first side 432a and an opposing second side 432b where the stator winding is arranged to be provided on the respective side by means of that the cooling member divides the space of the stator. The cooling member 432 further has an end portion 432c arranged to thermally conductive abut a portion of the stator back of the stator. The cooling member transcends in the area opposing the end portion 432c of the cooling member 432 to the retention portion 434. The retention portion 434 has an end portion 434c arranged to face the rotor. The retention portion 434 extends substantially circumferentially from the respective side of the cooling member 432 so that the opening of the space of the stator is covered. The retention portion 334 hereby has a side 434a, 434b arranged to outwardly face the envelope surface of the stator against which the stator winding is arranged to rest.

The means 430 differs from the means 130 in that the cooling member 432 of the means 430 comprises cooling conduits C. According to this embodiment of the device said cooling member 432 comprises conduits C extending axially for flow of cooling medium for example oil. Hereby is enabled efficient cooling by means of a cooling medium in the form of for example oil without the need for sealing of the air gap at the side of the stator facing the rotor.

The cooling medium is according to a variant arrange to be pumped in said conduits C by means of a pump unit, not shown.

The cooling member 432 according to this example has four conduits. The cooling member 432 may have any suitable number of conduits with any suitable shaping. The cooling member 432 has at least one conduit.

Corresponding conduits are according to an embodiment arranged in any of the cooling members 132, 232, 234 of the embodiment in FIGS. 3, 4 and 5.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. A device for an electric motor having a rotor and a stator, wherein the stator comprises stator distributed frame portions provided between forming spaces for a stator winding, wherein said frame portions are arranged to support the stator winding and wherein a retainer is provided for retaining the stator winding in a thus formed space in place and for providing a short circuit protection function for the stator winding in said space, wherein said retainer comprises cooling members, which are in thermally conductive contact with a back portion of said stator for purpose of cooling.

2. The device according to claim 1, wherein said cooling member comprises thermally conductive portions of said retainer extending radially of the stator.

3. The device according to claim 1, wherein said retainer comprises portions having a substantially T-shaped cross section across the stator winding.

4. The device according to any of claim 1, wherein said cooling member comprises stator back portions extending radially from the stator back.

5. The device according to claim 4, wherein said stator back portions extending radially from the stator back comprises said portions having a substantially T-shaped cross section.

6. The device according to any of claim 1, wherein said short circuit protection function is arranged to be achieved by the cooling members of said retainer arranged to separate stator winding portions in said space.

7. The device according to any of claim 1, wherein said cooling member comprises conduits extending axially for flow of cooling medium.

8. A platform comprising a device according to any of claim 1.

9. The platform according to claim 8, comprising a vehicle.
